(19) United States
(12) Patent Application Publication
(10) Pub. No.: US 2015/0268178 A1
(43) Pub. Date: Sep. 24, 2015

(54) Method of Subsea Testing Using a Remotely Operated Vehicle

(71) Applicant: Nautilus Minerals Pacific Pty Ltd, Milton, Queensland (AU)

(72) Inventors: Glen Smith, Milton (AU); Stuart Leach, Milton (AU)

(21) Appl. No.: 14/416,628

(22) PCT Filed: Jul. 10, 2013
(86) PCT No.: PCT/AU2013/000762

§ 371 Date: Jan. 22, 2015

(30) Foreign Application Priority Data
Jul. 27, 2012 (AU) 2012903243

(51) Int. Cl. G01N 23/223; B63G 8/00; G01N 23/222

(52) U.S. Cl. CPC G01N 23/223; G01N 23/222; B63G 8/001; G01N 2223/076; G01N 2223/616; G01N 2223/074; B63G 2008/007

(57) ABSTRACT

A method of subsea testing using a remotely operated vehicle (ROV) is provided. The ROV has a spectroscopic sensor, preferably an x-ray fluorescence or neutron activation analysis sensor. The method includes identifying seafloor material to analyse, directing the ROV to the identified seafloor material, and analysing the seafloor material with the spectroscopic sensor. The method allows real time, or at least near real time, analysis of seafloor materials of interest without the need to obtain samples for analysis at the surface.

### FIELD OF THE INVENTION

The invention relates to a method of subsea testing using a remotely operated vehicle (ROV). In particular, the invention relates, but is not limited, to a method of testing seafloor material using a remotely operated vehicle equipped with a spectroscopic sensor such as an x-ray fluorescence (XRF) sensor or a neutron activation analysis (NAA) sensor.

### BACKGROUND TO THE INVENTION

Reference to background art herein is not to be construed as an admission that such art constitutes common general knowledge in Australia or elsewhere.

Seafloor mining operations in which seafloor material, typically seafloor deposits such as seafloor massive sulphides, are mined and conveyed to a surface vessel for processing are being developed. Many challenges arise from working in such an underwater environment, particularly when operating in deep bodies of water such as 1000-3000 m+ below sea level.

One of these challenges is in analysing seafloor material. Typically sample material is collected and conveyed to the surface vessel for testing. However, obtaining samples is a complicated, time consuming, and expensive process.

One method of obtaining a sample is to send a specialised remotely operated vehicle (ROV) with multi-function manipulators down to the seafloor to physically obtain the sample and bring it back to the surface. However, once at the seafloor, material that is suitable to be removed must first be identified, such as a ‘chimney’ or rocky out-crop. The ROV, which has limited control, must then attempt to break off a piece of the rock with the multi-function manipulators. In many cases the sample: is too strong to be broken off by the ROV, is crushed in the process, is too big to handle, or is accidentally dropped. Even if a good sample is obtained by the ROV, it needs to be placed in a container on the seafloor and subsequently recovered to the surface. This retrieval operation increases complexity and requires additional components to be utilised, including a winch system to deploy and recover the sample container from the seafloor.

Another method is to use wax sampling, in which a small weight with a small piece of wax is dropped onto the seafloor and the wax adheres to small particles that can be retrieved and analysed. However, this method is very inefficient as only a limited amount of randomly selected particles are retrieved, and the particles that are retrieved are relatively small which limits the level of analysis that can be conducted.

Yet another sampling method is to use push core or box core sampling in which a relatively shallow core sample is taken from an apparatus that is plunged into the seafloor surface. However, this method is only suitable for soft sediment, and is not suitable to obtain a hard rock mineralised sample.

Not only is it onerous to obtain sample material as described above, but it is not until the samples have been retrieved and tested that an analysis of the seafloor material can be made. This time delay can be significant, and introduces a substantial inefficiency in understanding the characteristics of the seafloor material. This results in wasted mining time and resources.

### OBJECT OF THE INVENTION

It is an aim of this invention to provide a method of subsea testing using a remotely operated vehicle which overcomes or ameliorates one or more of the disadvantages or problems described above, or which at least provides a useful alternative.

Other preferred objects of the present invention will become apparent from the following description.

### SUMMARY OF INVENTION

According to a first aspect of the invention, there is provided a method of subsea testing using a remotely operated vehicle with a spectroscopic sensor, the method comprising the steps of:

identifying seafloor material to analyse;
directing the remotely operated vehicle to the identified seafloor material; and
analysing the seafloor material with the spectroscopic sensor.

Preferably the spectroscopic sensor includes an x-ray fluorescence sensor and/or a neutron activation analysis sensor. The step of analysing the seafloor material with the spectroscopic sensor preferably includes analysing the seafloor material with the x-ray fluorescence sensor and/or the neutron activation analysis sensor.

Preferably the step of analysing the seafloor material comprises using data from the x-ray fluorescence sensor and/or the neutron activation analysis sensor to determine mineral composition of the seafloor material. Preferably the method further comprises the step of determining a mineral grade estimate of the seafloor material using data from the analysis of the seafloor material. The seafloor material to analyse preferably includes seafloor sediment, hard rock, and/or structures.

Preferably the method further comprises the step of generating spectroscopic data from the analysis of the seafloor material with the spectroscopic sensor. The method may further comprise the step of storing data from the spectroscopic sensor. The data may be stored on board the remotely operated vehicle and/or at a remote location. The method preferably further comprises the step of transmitting the data from the spectroscopic sensor, typically to a surface vessel or platform. The data is preferably transmitted in real time or near real time, but may also be transmitted (or re-transmitted) at a later time.

The remotely operated vehicle may be tethered, preferably by an umbilical cable to a surface vessel or other seafloor equipment such as seafloor mining, cutting, or stockpiling vehicles. The remotely operated vehicle may be powered and controlled via the umbilical cable. Preferably data is transmitted over the umbilical cable. The data may also be able to be downloaded from the remotely operated vehicle directly.

Preferably the step of directing the remotely operated vehicle comprises locating the spectroscopic sensor adjacent the identified seafloor material. The spectroscopic sensor preferably comprises a waterproof housing that is pressure rated and suitably pressure tested for the depth of use. The waterproof housing may have an x-ray fluorescence and/or a neutron transmissive window. The step of locating the x-ray fluorescence and/or neutron activation analysis sensor adjacent the identified seafloor material preferably comprises using a remotely operated vehicle (ROV) manipulator arm or remotely actuated probe to position the transmissive window towards the identified seafloor material to analyse.

Preferably the remotely operated vehicle is operated from a surface vessel or platform. The remotely operated vehicle may also be automated or partially automated. The remotely operated vehicle may have a seafloor material identification system for identifying seafloor material, which may be of interest, to be analysed.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 is a diagrammatic view of a seafloor operation including a remotely operated vehicle (ROV) testing seafloor material;

FIG. 2 is a diagrammatic perspective view of a seafloor operation including a remotely operated vehicle (ROV) being used in conjunction with a seafloor bulk cutter (SBC);

FIG. 3 is a diagrammatic perspective view of the seafloor operation illustrated in FIG. 2 with the ROV being tethered to the SBC; and

FIG. 4 is a flow chart illustrating steps of a method of subsea testing using a ROV.

### DETAILED DESCRIPTION OF THE DRAWINGS

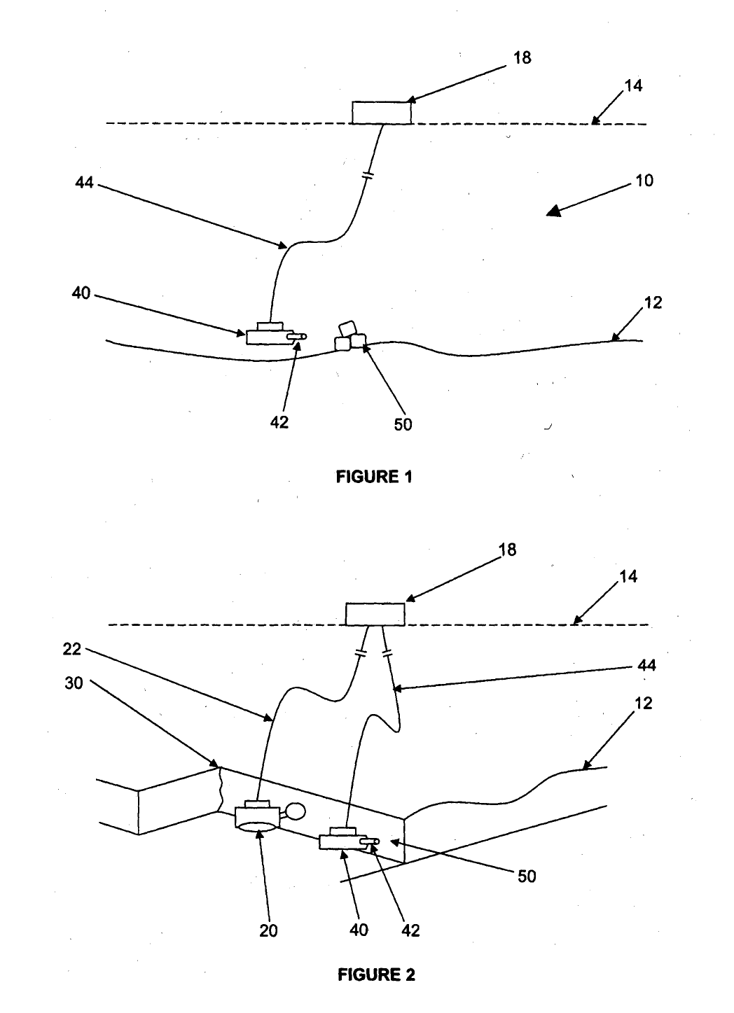

FIG. 1 illustrates a diagrammatic view of a seafloor operation 10 being conducted on a seafloor 12 below sea level 14. The seafloor operation 10 may be located at various depths below sea level 14, but typically the seafloor 12 will be greater than 1000 m below sea level 14 and, in many cases, approximately 2000 to 3000 m below sea level 14.

The seafloor operation 10 includes a remotely operated vehicle (ROV) 40 that is able to traverse the seafloor 12. The remotely operated vehicle 40 may be buoyant and/or may drive on the seafloor 12. The remotely operated vehicle has a spectroscopic sensor in the form of an x-ray fluorescence (XRF) and/or a neutron activation analysis (NM) sensor 42. It will be appreciated that a single spectroscopic sensor in the form an XRF or NM sensor will typically be provided. Alternatively, both an XRF and a NM sensor may be provided. The XRF and/or NM sensor 42 is mounted in a pressure rated housing with an XRF and/or NM transmissive window.

The remotely operated vehicle 40 is also connected to a surface vessel or platform 18 via an ‘umbilical’ cable 44. The umbilical cable 44 provides the remotely operated vehicle 40 with power, control, and telemetry. Typically the remotely operated vehicle 40 is powered and operated remotely, via the umbilical cable 44, from the surface vessel or platform 18. Although the surface vessel or platform 18 is illustrated as being located on the surface of the sea level 14, it will be appreciated that the surface vessel or platform could also be located elsewhere, such as on land. Umbilical cable 44 may, or may not, be connected to, or integrated with, an umbilical cable for other seafloor equipment (not shown in FIG. 1). It will also be appreciated that the remotely operated vehicle 40 could have its own power source, e.g. battery power, and be operated via a wireless communications means.

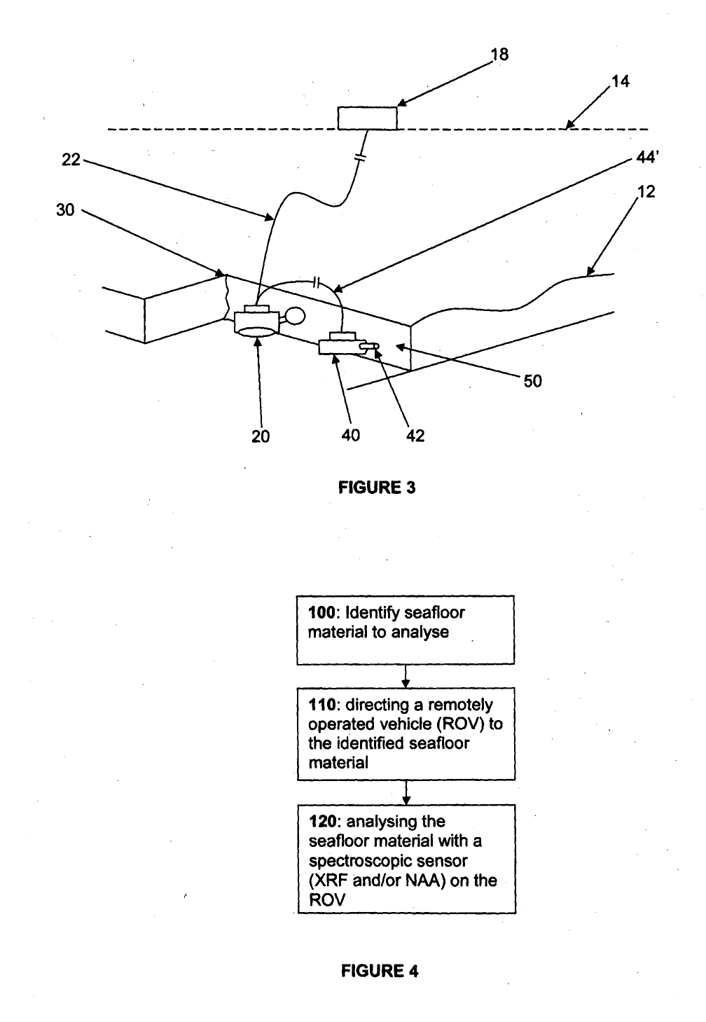

Seafloor 12 has a seafloor material 50 to be analysed. The seafloor material 50 typically includes seafloor sediment, hard rock and/or seafloor structures. The seafloor material 50 may be naturally occurring or may be recently exposed material, such as from an exposed bench as a result of a seafloor mining operation. FIGS. 2 and 3 illustrate the remotely operated vehicle 40 operating in conjunction with a seafloor mining vehicle operating on a newly created seafloor bench 30. As shown in FIG. 2, the seafloor mining vehicle 20 is also connected to the surface vessel or platform 18 via a second umbilical cable 22. The seafloor material 50 is a recently exposed portion of the seafloor bench 30.

FIG. 3 illustrates the remotely operated vehicle 40 being used in conjunction with a seafloor mining vehicle 20 as illustrated in FIG. 2, but instead of the seafloor mining vehicle 40 having its own umbilical cable (44 in FIGS. 1 and 2) to the surface vessel or platform 18, it has an umbilical tether 44′ which is connected between the remotely operated vehicle 40 and the seafloor mining vehicle 20. The remotely operated vehicle 40 may still receive power and communicate with the surface vessel or platform 18, but it is instead via the umbilical cable 22 of the seafloor mining vehicle 20.

In an embodiment the remotely operated vehicle 40 may be carried by the seafloor mining vehicle 20 until needed, at which time it separates from the seafloor mining vehicle 20 to analyse seafloor material 50 of interest. For example, the remotely operated vehicle 40 may be utilised to conduct mineralised grade measurements as the seafloor mining vehicle 20 exposes new material.

In use, the seafloor material 50 to be analysed is first identified for analysis (step 100 of FIG. 4). The seafloor material 50 may be identified through variety of different means, but typically the remotely operated vehicle 40 will have some form of seafloor material identification system. The seafloor material 50 to be analysed may be identified by taking seafloor measurements (e.g. sonar), by visual identification (e.g. via a camera), and/or by using historical data.

Once the seafloor material 50 to analyse is identified, the remotely operated vehicle 40 is directed to the identified seafloor material (step 110 of FIG. 4) and the XRF and/or NAA sensor 42 is located adjacent the identified seafloor material 50. Typically the XRF and/or NAA sensor is mounted on a manipulator arm of the remotely operated vehicle 40. The manipulator arm, or actuated probe, is manoeuvrable with respect to the rest of the remotely operated vehicle 40 and is preferably controlled remotely, typically from the surface vessel or platform 18. Once the XRF and/or NM sensor is located adjacent the identified seafloor material 50, the identified seafloor material 50 can, be analysed by the XRF and/or NM sensor 42 (step 120 of FIG. 2).

Data from the XRF and/or NM sensor 42 is stored and transmitted over the umbilical cable 44 or umbilical tether 44′ to the surface vessel or platform 18. Where the remotely operated vehicle 40 doesn't have an umbilical cable 44 or umbilical tether 44′, the data may be transmitted wirelessly (e.g. to the surface vessel or platform 18 or to other seafloor equipment such as a seafloor mining vehicle 20) and/or downloaded from the remotely operated vehicle 40 at a suitable time (e.g. when the remotely operated vehicle 40 is retrieved).

Advantageously the invention allows testing of seafloor material 50, such as seafloor sediment, hard rock and structures, remotely using a remotely operated vehicle 40. The XRF and/or NM sensor 42 of the remotely operated vehicle 40 is used to provide composition and mineral grade estimates of the seafloor material 50 which can be used to improve knowledge of the seafloor 12 as well as to provide mining guidance to, and therefore enhance, seafloor mining operations.

The method of operating a remotely operated vehicle 40 in accordance with the invention is more efficient than using existing remotely operated vehicles with manipulators that strive to obtain physical samples from the seafloor. Furthermore, the remotely operated vehicle 40 in accordance with the invention avoids various problems associated with obtaining physical samples such as not being able to obtain a sample, damaging a sample, losing a sample, etc. Furthermore, it allows for real-time analysis of seafloor material, avoiding the delays, and associated inefficiencies, in obtaining and analysing physical samples.

The remotely operated vehicle 40 is easily utilised to provide relatively rapid data collection and analysis on seafloor material 50, allowing quick and accurate assessments to be made which in turn allows for informed decisions to be made in a timely manner. For example, the remotely operated vehicle 40 may be utilised to provide timely analysis of a seafloor bench after it has been mined to confirm, and update if necessary, mineralisation estimates of the actual seafloor material being mined. Furthermore, the remotely operated vehicle 40 may be utilised to screen potential seafloor drilling sites, cost effectively selecting or rejecting mineralised targets for drilling.

Due to the ease and efficiency of operation of the remotely operated vehicle 40 compared to previous seafloor sample systems, larger amounts of seafloor material 50 can be analysed than was previously practical. The composition and mineral grade estimates of the seafloor material 50 advantageously provide valuable information on the state of the seafloor 12 and, in particular, allow seafloor mining operations to focus on areas of high value.

It will be appreciated that other sensors and measurements may also be made using different sensors, typically mounted on the remotely operated vehicle 40, and that these may assist in determining other characteristics of the seafloor material 50, the seafloor 12, and/or the environment.

References herein to the seafloor, seabed, subsea, or the like are for convenience only and could equally be applied to other bodies of water such as, for example, a lake with a lakebed, etc.

In this specification, adjectives such as first and second, left and right, top and bottom, and the like may be used solely to distinguish one element or action from another element or action without necessarily requiting or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A method of subsea testing using a remotely operated vehicle with a spectroscopic sensor, the method comprising the steps of:
identifying seafloor material to analyse;
directing the remotely operated vehicle to the identified seafloor material; and
analysing the seafloor material with the spectroscopic sensor.

2. The method of claim 1, wherein the spectroscopic sensor includes an x-ray fluorescence sensor.

3. The method of claim 1, wherein the spectroscopic sensor includes a neutron activation analysis sensor.

4. The method of claim 1, wherein the step of analysing the seafloor material comprises using data from the spectroscopic sensor to determine mineral composition of the seafloor material.

5. The method of claim 1, further comprising the step of determining a mineral grade estimate of the seafloor material using data from the analysis of the seafloor material.

6. The method of claim 1, wherein the seafloor material to analyse includes seafloor sediment, hard rock, and/or structures.

7. The method of claim 1, wherein the method further comprises the step of generating spectroscopic data from the analysis of the seafloor material with the spectroscopic sensor.

8. The method of claim 7, further comprising the step of storing the spectroscopic data.

9. The method of claim 8, further comprising the step of transmitting the spectroscopic data.

10. The method of claim 9, wherein the spectroscopic data is transmitted in real time or near real time.

11. The method of claim 1, wherein the remotely operated vehicle is tethered.

12. The method of claim 11, wherein the remotely operated vehicle is tethered to a surface vessel.

13. The method of claim 11, wherein the remotely operated vehicle is tethered to seafloor equipment.

14. The method of claim 11, wherein the remotely operated vehicle is tethered via an umbilical cable.

15. The method of claim 14, wherein the remotely operated vehicle is powered and controlled via the umbilical cable.

16. The method of claim 14, wherein data from the spectroscopic sensor is transmitted over the umbilical cable.

17. The method of claim 1, wherein the step of directing the remotely operated vehicle comprises locating the spectroscopic sensor adjacent the identified seafloor material.

18. The method of claim 1, wherein the spectroscopic sensor comprises a waterproof housing that is pressure rated and suitably pressure tested for the depth of use.

19. The method of claim 18, wherein the waterproof housing has an x-ray fluorescence and/or a neutron transmissive window.

20. The method of claim 19, wherein the step of locating the x-ray fluorescence and/or neutron activation analysis sensor adjacent the identified seafloor material comprises positioning the transmissive window towards the identified seafloor material to analyse.

21. The method of claim 1, wherein the remotely operated vehicle is operated from a surface vessel or platform.

22. A method of generating spectroscopic data relating to seafloor material, the method including the steps of:
identifying seafloor material to analyse;
directing the remotely operated vehicle to the identified seafloor material;
analysing the seafloor material with a spectroscopic sensor; and
generating spectroscopic data from the spectroscopic sensor analysing the seafloor material.
